(19) United States
(12) Patent Application Publication
(10) Pub. No.: US 2018/0047330 A1
(43) Pub. Date: Feb. 15, 2018

(54) RICH ENTERPRISE SERVICE-ORIENTED CLIENT-SIDE INTEGRATED-CIRCUITRY INFRASTRUCTURE, AND DISPLAY APPARATUS

(71) Applicant: Jacob Villarreal, Carrollton, TX (US)

(72) Inventor: Jacob Villarreal, Carrollton, TX (US)

(21) Appl. No.: 15/655,989

(22) Filed: Jul. 21, 2017

Related U.S. Application Data
(60) Provisional application No. 62/372,722, filed on Aug. 9, 2016.

(51) Int. Cl. G09G 3/20; G09G 3/36

(52) U.S. Cl. CPC G09G 3/2096; G09G 3/3648; G09G 2370/16; G09G 2330/021

(57) ABSTRACT

The present disclosure relates specifically to a smart host integrated-circuitry infrastructure, and display apparatus which function integrally as a smart computing platform for connectivity with a rich enterprise server-side infrastructure, for cross-platform implementation of rich enterprise service-oriented framework applications for home, and business computing environments. A built-in modular framework of integrated-circuitry infrastructure components serves as the system line-circuitry interface which provides display apparatus with cross-platform stand-alone, and client-side graphical user interface capabilities. A multi-protocol interface provides the display apparatus with host, session, and data resolution capabilities. A multi-channel short-range wireless signal transceiver provides the system interface with wireless peripheral interconnectivity with remote hosts, and devices such as wireless gateways, wireless keyboards & mice, wireless smart phones, wireless IoT devices, and the like. An audio interface connector port provides wired connectivity with audio peripheral devices. A micro-B USB interface connector port provides wired connectivity with micro-B USB compatible peripheral devices. A built-in web camera, and microphone provide audio-visual portability for video, and voice messaging between compatible nodes. A battery compartment serves as the housing for a rechargeable battery.

### BACKGROUND OF THE INVENTION

The background of the invention relates, specifically, to a client-side integrated-circuitry infrastructure, and display apparatus, referred to as a smart host computing apparatus, which consists of a complex integrated-circuitry infrastructure, and a display apparatus, which is used for housing both, the integrated-circuitry infrastructure, and display panel assembly. Graphical data is typically rendered on the display panel by means of a microcontroller which drives the video transmission onto the display panel's integrated line-circuitry architecture in the form of pixel data for graphical display on the panel.

Display technology has been implemented in the computing industry since the 1950s, and consisted of technologies such as the blinking indicator lights, teletype, punch cards, and paper tape, which would output the signal data as light indications, punch holes, and pixel data. Later display technology would output the signal data in the form of pixel data on a CRT display to form letters, numbers, and other graphical forms of output. The more innovative computing display technology platforms have been in use since the 1970s. These display devices consisted mainly of a cathode ray tube (CRT), or plasma infrastructure, which eventually became too bulky, or unfavorable for consumers, and were phased out of the consumer market by the mid 1980s. Liquid crystal display (LCD) display technology platforms in later years eventually phased CRT display technology out of the market. A typical LCD apparatus in its entirety consists of a variation of liquid crystal material, a variation of a backlight (CCFL, or LED), a variation of a standard power supply board, a microcontroller, a standard housing (which encases all of the internal parts), a variety of interface ports, and a variety of control buttons.

Some LCD displays came to be known, and implemented as thin clients, known for their minimal processing capabilities, for localized access to remote resources, such as virtual desktop infrastructures, and applications (with processing handled by a remote server), usually located in a remote information center.

There are several desktop, and application virtualization products available in the present-day market, such as VMWare's Horizon, and Citrix's XenApp and XenServer, which enable virtualization administrators to deploy, and manage multiple virtual desktops, virtual applications, and cloud infrastructures simultaneously.

Most computer terminal equipment falls under three categories, being zero client, web client, and thin client. Zero clients consist of a very lightweight firmware which allow them to initialize network communication through a basic GUI, and come in the form of a ‘small-chassis’ peripheral device that connects with the display by means of a wired connection. Web clients only provide a web browser, and rely on web applications to provide general-purpose computing functionality. Thin clients act as lightweight computers purpose-built for remote access to a server, and are used mainly in business applications that require desktop, and application virtualization for client access to business resources.

Most display terminals with built-in zero client, and thin client capabilities have been phased out of the market, leaving computer terminal products which consist mainly of handheld devices used for point-of-sale systems and logistics, while others are built as ‘small-chassis’ peripheral computing products, with very few such as the HP Zero Client t310 all-in-one display terminal consisting of a display for graphical interactive use.

The marketability of most computer terminal products to-date is business-centric, focused mainly on desktop virtualization for business applications, with only a minor focus for use in home computing environments.

This presents a need for a more innovative client-side hardware design infrastructure which provides product consumers with more enhanced marketability, greater computing capabilities, and a more intuitive clutter-free platform for development of a more comprehensive global business networking/internetworking infrastructure.

### A BRIEF SUMMARY OF THE INVENTION

In reference to FIGS. 1 through 20, the preferred embodiment of the present invention is a client-side integrated-circuitry infrastructure, and display apparatus referred to as a smart host computing apparatus. The hardware infrastructure is invariably constituent of, but is not limited to, seven components, namely, a display housing assembly, at least one multi-render interface (MRI) display panel, at least one oblong line-circuitry (OLC) silicon microchip, at least one standard HD web camera interface component, at least one hardware interface component, at least one internal lamp interconnect component, at least one power supply interface component, and at least one power circuitry board component.

The MRI display panel architecture consists of a liquid crystal display thin-film circuit (TFC) integrated line-circuitry infrastructure which consists of multiple MRI components, and at least one standard LCD film containing any of a variety of liquid crystal chemical compositions serves as the electro-optical material utilized for color polarization, wherein at least one multi-access polarization (MAP) component serves as the primary line circuitry for electronic color polarization, and at least one multi-access capacitance (MAC) component serves as the line-circuitry for supply current for the MAP component.

The MRI display panel architecture is a stack-oriented integrated line-circuitry architecture which is designed for inline access from multiple stacked MAP grids with line interconnects to sub-pixel circuits on the MAP component for electronic polarization of liquid crystal material. In one embodiment, the MAP component consists of a sub-pixel line-circuitry architecture which is lithographically etched onto a silicon substrate surface layer, which is coated on the reverse side with any one of a variety of polymers, such as polyvinyl-alcohol, a polymide, or a silane. This polymer-coated design enables the surface base to serve as a wavelength diffusion film for sub-pixel polarization of liquid crystal material. The MAC component is an electrode-oriented integrated line-circuitry architectural component which is designed for constant supply of electric current to sub-pixel circuits located on the MAP component. In one embodiment, the MAC component consists of an micro-electrode line-circuitry architecture consisting of micro-capacitance circuits, and resistance alloy integrated-circuitry line (RAIL) elements which are lithographically etched, over the MAP component, onto a dielectric substrate surface layer, consisting of one of any of a variety of high-k dielectric substrates, such as hafnium silicate, zirconium silicate, hafnium dioxide, or zirconium dioxide. This dielectric design enables the surface base to serve as a dielectric intermediary substrate between MAC, and MAP components for enhancement of mobility of charge carriers, and electric potential thereof to sub-pixel electrodes on the MAP component. The MAC component is an integrated line-circuitry architectural sub-component which is designed for electronic steering of positively charged electrical current contained in sub-pixel circuits, located on the MAP component, to the negative voltage supply on the MAC component.

The OLC microchip consists of a framework of multiple transistor bit set assemblies which serve integrally as a modular integrated-circuitry infrastructure consisting of multiple memory infrastructure components which are utilized by the system interface for its graphical interactive multi-rendering capabilities.

The HD web camera interface component is designed to fit compactly within the display housing for interconnection with the power circuitry board. The HD web camera interface component serves as the audio-visual interface for audio/video messaging capabilities by means of a built-in audio microphone, and minimal high-definition resolution ranging from 720p to 1080p.

The hardware interface component consists of at least three integrated components for hard-wired electrical connectivity with external hardware devices, and power control operability. It serves as the hardware interface for audio connectivity, micro-B USB connectivity, and power control.

The internal lamp interface component consists of at least one interconnect component which interconnects with the power circuitry board for electrical power transfer to the backlight, or sidelight lamps.

The power circuitry board component is designed to serve as a load-bearing framework built as a square frame-shaped technology board consisting of an integrated power supply interface component, and an electrical integrated-circuitry infrastructure which provides power regulation, and interconnection with multiple components.

The smart host computing apparatus consists of two user interface modes, namely, the stand-alone interface mode, and the client-side interface mode. The stand-alone infrastructure consists of a stand-alone object-oriented firmware applications infrastructure which enables the smart host computing apparatus to render a rich enterprise stand-alone graphical user interface consisting of a graphical object-oriented (GOO) software applications framework of rich enterprise service-oriented multi-media software applications, which enable the user to access both wired, and wireless peripheral devices, smart interactive products (such as smart phones, smart watches, smart appliances etc. . . . ), and multi-media hosts.

The client-side infrastructure consists of a similar object-oriented firmware applications infrastructure, but with extended capabilities which enable the smart host computing apparatus to access the enterprise network resource framework, and the client-side software applications infrastructure allocation located on a remote rich enterprise network operating systems (RENOS) server. It enables the user to perform computing tasks natively on a licensed allocation located on a remote server. The firmware applications infrastructure consists of the graphical user interface which enables the user to configure the smart host interconnectivity options, and enterprise internetworking options, for seamless cross-platform enterprise interconnectivity, and integration with RENOS servers, and other smart host computing devices.

The client-side software applications infrastructure provided by RENOS servers consists of a GUI transport software applications infrastructure which enables the server to transport graphical user interface object data more efficiently by means of the object transport layering protocol, which layers GUI objects for next-layer transmission of succeeding object sub-layers for optimal management of object data overhead. A multi-media frame-work, and an aspect ratio object-oriented data structure provide optimized object refresh rendering on object resizing, and object scrolling GUI tasks.

The smart host computing apparatus is a smart display that acts as a thin client, but with a built-in infrastructure that enables it to perform like a desktop. The smart host computing apparatus also enables the user to access his/her wireless home internet connection without the need for an operating system, or built-in data storage components. It's an innovative computing platform that provides the user with a multi-interface infrastructure which consists of the portability that allows the smart host to act as a standalone host interface for simple internet, and multi-media computing tasks, and to create a remote operating session with an enterprise portal server of preference. What makes it different from typical thin clients is its universal cross-platform scalability, and portability. It's a powerful computing platform that's more scalable, and portable than most desktop computing platforms on the market. It creates an actual native operating systems session on a remote enterprise server containing the personally licensed operating system, which allows subscribers secure access to all of the operating system's native resources allowing the user to perform all of his/her native computing tasks more richly, and powerfully than on most platforms. You can install new software applications like you would on a desktop computer, even more securely than you would on a desktop. It's a fully functional operating system located on a remote server, and a rich enterprise graphical user interface transport infrastructure for seamless transport of OS graphics.

It finds, and synchs up all of your local wireless devices, such as smart phones, wireless peripherals, even compatible desktop computers, and all of your IoT smart devices autonomously. It presents a whole new enterprise extra-networking infrastructure for the future, with a more innovative open cloud internetworking infrastructure than other competitors, and allows you to choose your enterprise portal, clouds, and other app resources graphically, and provides a more collective web surfing experience, kind of like mall shopping with other online consumers, but without the virtual reality.

The virtual operating systems session is even more secure, and even more confidential than your standard desktop computing sessions. Only the subscriber has access to his/her own licensed operating system, with the scalability that allows the user to uninstall, and reinstall the operating system whenever he/she wants, without the need for an administrator, or technical support engineer. It's so confidential, only the subscriber has access to the operating system, and data; not even the administrator has access to any of the licensed allocations.

The enterprise server platform, referred to as a smart Renos systems applications architecture platform (SAAP), has access restriction built-in, which specifically restricts all administrative/remote-host access to licensed allocations. Only your personal interactive use is what determines the access to your data storage allocations. Your data is secured by your personal backup preferences, and there are other enterprise backup subscription options available which offer high-availability enterprise raid backup solutions for clientele.

In summary, the smart host alleviates the computing environment of clutter, and complexity, as it is a completely wireless networking solution, and has no internal device components, and no internal storage, only a built-in web camera, a hardware interface port, and wireless portability. It's also battery-compatible, and energy-efficient, and includes a built-in battery compartment.

### A BRIEF DESCRIPTION OF THE DRAWINGS

FIG. 1 illustrates a view of the front of one embodiment of an invariably constituent variation of the display apparatus, and its invariably constituent parts.

FIG. 1A illustrates one embodiment of an invariably constituent variation of a liquid crystal display panel.

FIG. 1B illustrates one embodiment of an invariably constituent variation of a built-in HD web camera interface component.

FIG. 1C illustrates one embodiment of an invariably constituent variation of a built-in wireless communication port.

FIG. 2 illustrates a view of the right side of one embodiment of an invariably constituent variation of the display apparatus, and its invariably constituent parts.

FIG. 2A illustrates one embodiment of an invariably constituent variation of a built-in power control button.

FIG. 2B illustrates one embodiment of an invariably constituent variation of a built-in audio interface port, and a built-in micro-B USB interface port.

FIG. 3 illustrates a view of the rear of one embodiment of an invariably constituent variation of the display apparatus, and its invariably constituent parts.

FIG. 3A illustrates a view of one embodiment of an invariably constituent variation of an external cover for a battery compartment.

FIG. 3B illustrates one embodiment of an invariably constituent variation of a built-in hardware interface component.

FIG. 3C illustrates one embodiment of an invariably constituent variation of a built-in power adapter connector port.

FIG. 3D illustrates one embodiment of an invariably constituent variation of a built-in display stand.

FIG. 4 illustrates a simplified view of the front, and rear of one embodiment of an invariably constituent variation of the internal framework of the smart host apparatus, and its invariably constituent parts.

FIG. 4A illustrates a simplified view of the front of an invariably constituent variation of the OLC silicon microchip, consisting of one or more built-in wireless connectivity RF modules, and located at the right side of the display panel assembly.

FIG. 4B illustrates a simplified view of the front of an invariably constituent variation of a MRI display panel assembly.

FIG. 4C illustrates a simplified view of an invariably constituent variation of the independently electrically connected wireless connectivity component located at the upper left corner of the display panel assembly.

FIG. 4D illustrates a simplified view of an invariably constituent variation of the internal battery interconnect port located at the center of the rear of the multi-access polarization display panel assembly.

FIG. 4E illustrates a simplified view of the front of one embodiment of an invariably constituent variation of the ultra-thin lamp slot located at the left side of the display panel assembly.

FIG. 4F illustrates a simplified view of an invariably constituent variation of the built-in hardware interface component consisting of an audio hardware interface connector port, a micro-USB hardware interface connector port, and a power control button.

FIG. 5 illustrates a simplified view of one embodiment of the entire assembly of the of the display apparatus, and its invariably constituent parts.

FIG. 5A illustrates a diagonal view of a simplified depiction of the front cover panel of the display housing assembly.

FIG. 5B illustrates a diagonal view of a simplified depiction of the CCFL lamp, or LED backlight component.

FIG. 5C illustrates a diagonal view of a simplified depiction of the OLC silicon microchip.

FIG. 5D illustrates a simplified diagonal view of a simplified depiction of the LCD panel.

FIG. 5E illustrates a simplified diagonal view of a simplified depiction of the power circuitry board.

FIG. 5F illustrates a simplified diagonal view of a simplified depiction of one OLC interconnect port located on the power circuitry board.

FIG. 5G illustrates a simplified diagonal view of a simplified depiction of the hardware interface component.

FIG. 5H illustrates a simplified diagonal view of a simplified depiction of the lamp component interconnect port located on the power circuitry board.

FIG. 5I illustrates a simplified diagonal view of a simplified depiction of the HD web camera interface component.

FIG. 5J illustrates a simplified diagonal view of a simplified depiction of the convex exterior of the battery compartment.

FIG. 5K illustrates a simplified diagonal view of a simplified depiction of the battery interconnect port which interconnects with the power circuitry board.

FIG. 6 illustrates a simplified diagram of the embodiment of an invariably constituent variation of the MRI display panel, and the OLC silicon microchip design framework.

FIG. 6A illustrates a simplified depiction of a rectangular rendition of the OLC silicon microchip located at the top side of the display panel.

FIG. 6B illustrates a simplified depiction of a rectangular rendition of the OLC silicon microchip located at the right side of the display panel.

FIG. 6C illustrates a simplified depiction of a MAP quadrant located at the upper right-most corner of the display panel.

FIG. 7 illustrates a clarified view of one embodiment of an invariably constituent variation of the MRI display panel which points out the OLC interconnect ports, and their invariably constituent parts.

FIG. 7A illustrates a simplified diagonal view of an invariably constituent variation of the OLC interconnect port located at the top side of the MRI display panel.

FIG. 7B illustrates a simplified diagonal view of an invariably constituent variation of the OLC interconnect port located at the left side of the MRI display panel.

FIG. 8 illustrates a simplified view of one embodiment of an invariably constituent variation of the oblong line-circuitry silicon microchip design infrastructure, and its invariably constituent parts.

FIG. 8A illustrates a simplified cut-out view of one embodiment of an invariably constituent variation of the OLC silicon microchip design infrastructure consisting of three rows of female interconnect pins.

FIG. 8B illustrates a simplified cut-out view of one embodiment of an invariably constituent variation of the female-pin interconnect port, consisting of an aggregated female-pin interconnect design infrastructure.

FIG. 8C illustrates a simplified view of one embodiment of an invariably constituent variation of the female-pin power circuitry board interconnect.

FIG. 8D illustrates a simplified cut-out view of a second embodiment of an invariably constituent variation of the OLC silicon microchip design infrastructure consisting of three rows of female interconnect pins.

FIG. 8E illustrates a simplified cut-out view of one embodiment of an invariably constituent variation of the female-pin interconnect port, consisting of a non-aggregated female-pin interconnect design infrastructure.

FIG. 8F illustrates a simplified view of one embodiment of an invariably constituent variation of the female-pin power circuitry board interconnect.

FIG. 9 illustrates a simplified cut-out view of one embodiment of an invariably constituent variation of the multi-access polarization (MAP) component, and its invariably constituent parts.

FIG. 9A points out a data line extending along the vertical access.

FIG. 9B points out a data line extending along the horizontal access.

FIG. 9C points out a carrier, and load line signal transmissions intersecting at a corresponding coordinate.

FIG. 10 illustrates a view of the front, and reverse sides of one embodiment of an invariably constituent variation of the multi-access polarization (MAP) component, and its invariably constituent parts.

FIG. 10A points out a view from the front side of one embodiment of a data line that runs along the vertical axis.

FIG. 10B points out a view from the front side of one embodiment of a data line that runs along the horizontal axis.

FIG. 10C points out a view from the front side of one embodiment of a line intersect coordinate.

FIG. 10D points out a view from the front side one embodiment of a micro-electrode.

FIG. 10E points out a view from the reverse side of one embodiment of the horizontal polarization polymer film, consisting of one of a variety of polymers, such as polyvinyl-alcohol, a polymide, or a silane.

FIG. 10F points out a view from the reverse side of one embodiment of a data line interconnect.

FIG. 10G points out a view from the reverse side of one embodiment of a micro-electrode located on the MAP component.

FIG. 11 illustrates a view of the front, and reverse sides of one embodiment of an invariably constituent variation of the multi-access capacitance (MAC) component, and its invariably constituent parts.

FIG. 11A points out a view from the front side of one embodiment of a supply line located along the vertical axis.

FIG. 11B points out a view from the front side of one embodiment of a supply line located along the horizontal axis.

FIG. 11C points out a view from the front side of one embodiment of a micro-anode.

FIG. 11D points out a view from the reverse side of one embodiment of a RAIL element located behind the data line interconnect on the MAC component.

FIG. 11E points out a view from the reverse side of one embodiment of a micro-anode located on the MAC component.

FIG. 12 illustrates a detailed cut-out view of one embodiment of an invariably constituent variation of the MAP display panel architecture, and its invariably constituent parts.

FIG. 12A points out a simplified cut-out view of one embodiment of a MAC component, and its invariably constituent parts.

FIG. 12B points out a simplified cut-out view of one embodiment of the dielectric substrate surface layer located between the MAC, and MAP components.

FIG. 12C points out a simplified cut-out view of one embodiment of a MAP component, and its invariably constituent parts.

FIG. 12D points out a simplified view of one embodiment of a line interconnect between a MAC component, and a MAP component.

FIG. 12E points out the direction of the flow of the electric current of a signal transmission flowing from a line interconnect located on a MAC component to a sub-pixel circuit located on a MAP component, depicted as a dotted arrow located behind the figure of the MAC component.

FIG. 12F points out a simplified view of one embodiment of a micro-electrode located on the MAC component.

FIG. 12G points out a simplified view of one embodiment of a micro-electrode located on the MAP component.

FIG. 12H points out a simplified view of a dielectric polarization between the MAC component, and the MAP component, depicted as three bi-directional dotted arrows.

FIG. 13 illustrates a simplified diagram of one embodiment of the lithographic layers utilized in micro-fabrication of the MRI display panel architecture.

FIG. 13A illustrates a simplified depiction of a silicon substrate surface layer, such as Si, or SiO₂.

FIG. 13B illustrates a simplified depiction of the micro-electrode layer consisting of a standard photo-resist template, and copper substrate micro-electrode line circuitry.

FIG. 13C illustrates a simplified depiction of the line interconnect layer consisting of a standard photo-resist template, and line interconnect line circuitry.

FIG. 13D illustrates a simplified depiction of the dielectric layer consisting of a dielectric substrate surface layer for capacitance between MAC, and MAP components.

FIG. 13E illustrates a simplified depiction of the RAIL elementary layer consisting of RAIL elements.

FIG. 13F illustrates a simplified depiction of the data line, and capacitance circuits layer which consists of data line, and capacitance line circuitry.

FIG. 14 illustrates a simple diagram depicting one example of a preferred session between a two smart host computing apparatuses, one of which is a server.

FIG. 14A illustrates a simplified diagram illustrating a client-side infrastructure which consists of a client-side system interface, client-side object data, and a client-side session interface.

FIG. 14B illustrates a simplified diagram illustrating a server-side infrastructure which consists of smart rich enterprise network operating systems (RENOS) services, a smart server-side system interface, remote server-side resource object data, and a smart RENOS server-side session interface.

FIG. 14C illustrates a simplified diagram illustrating a simplified description of the interconnectivity interface between a smart host computing apparatus, and a smart server computing apparatus. In this example the interconnectivity interface consists of an interactive session protocol, interactive access to object data, and an interactive executive interface which provide smart host apparatuses with interactive instruction set execution capabilities.

FIG. 15 illustrates a simple diagram depicting one example of a preferred session between two smart host computing apparatuses.

FIG. 15A illustrates a simplified diagram illustrating a client-side infrastructure which consists of a client-side system interface, client-side object data, and a client-side session interface.

FIG. 15B illustrates a simplified diagram illustrating a second client-side infrastructure which consists of a client-side system interface, client-side object data, and a client-side session interface.

FIG. 15C illustrates a simplified diagram illustrating a simplified description of the interconnectivity interface between the two smart host computing apparatuses. In this example the interconnectivity interface consists of an interactive session protocol, interactive access to object data, and an interactive executive interface which provide smart host apparatuses with interactive instruction set execution capabilities.

FIG. 16 illustrates a simple diagram depicting one example of a preferred session between a smart host computing apparatus, and a wireless peripheral device.

FIG. 16A illustrates a simplified diagram illustrating a client-side infrastructure which consists of a client-side system interface, client-side object data, and a client-side session interface.

FIG. 16B illustrates a simplified diagram illustrating a wireless peripheral application infrastructure which consists of a device protocol interface, device object data, and a device session interface.

FIG. 16C illustrates a simplified diagram illustrating a simplified description of the interconnectivity interface between the two smart host computing apparatuses. In this example the interconnectivity interface consists of an interactive session protocol, interactive access to object data, and an interactive executive interface which provide smart host apparatuses with interactive instruction set execution capabilities.

FIG. 17 illustrates a process flow chart delineating a variation of the host type and codec resolution, and validation process flow implemented by the Host Interface Protocol (HIP).

FIG. 18 illustrates a process flow chart delineating a variation of the session type and codec resolution, and validation process flow implemented by the Session Interface Protocol (SIP).

FIG. 19 illustrates a simplified view of a preferred-session request process flow, depicting various computing devices required for interconnectivity with a remote enterprise portal service.

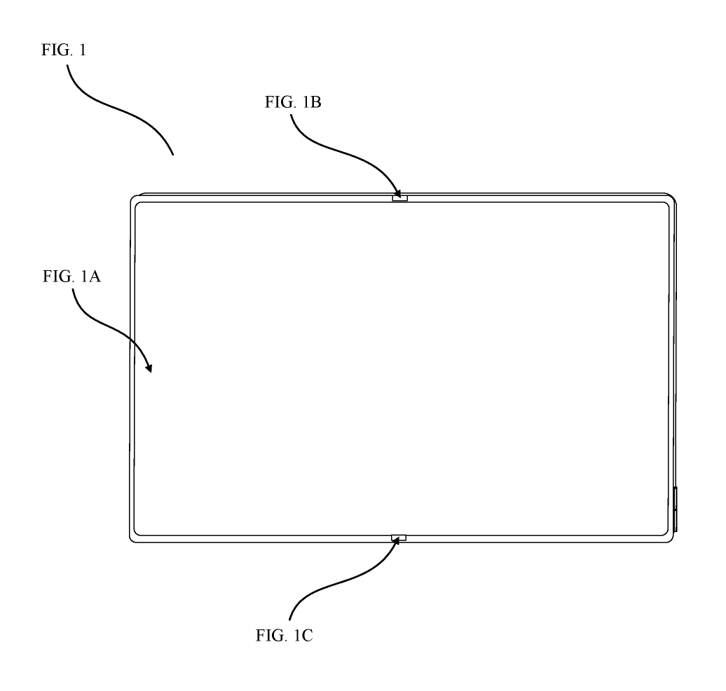

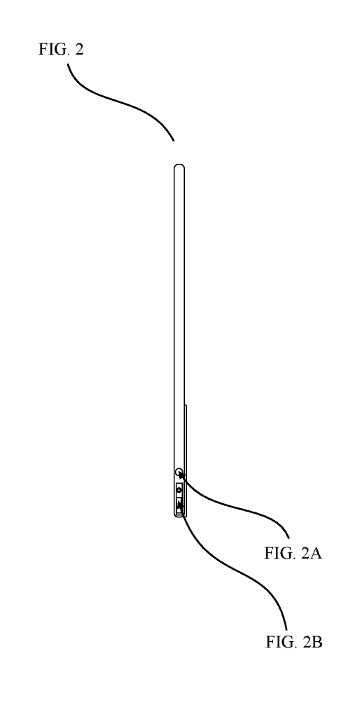

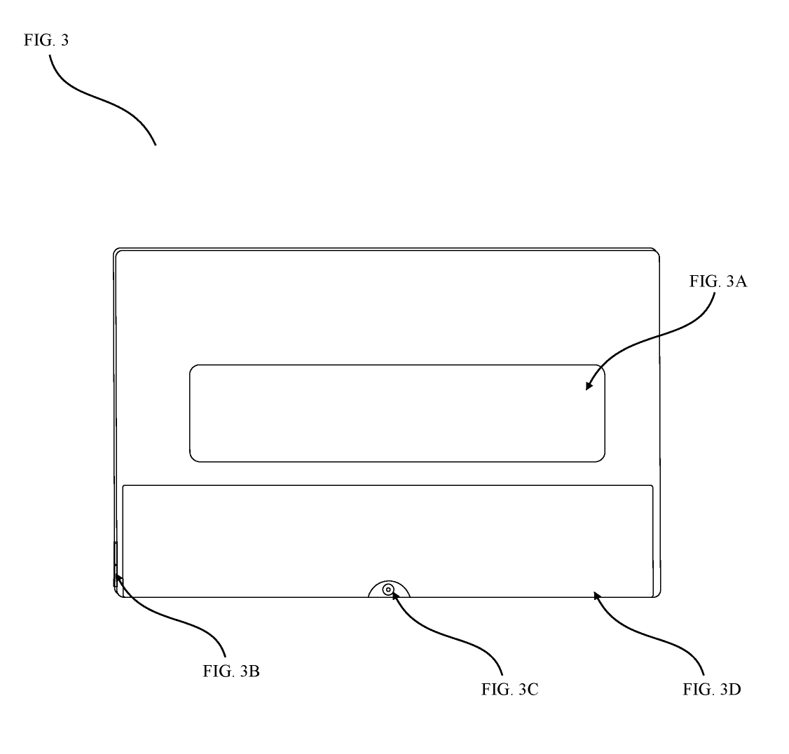

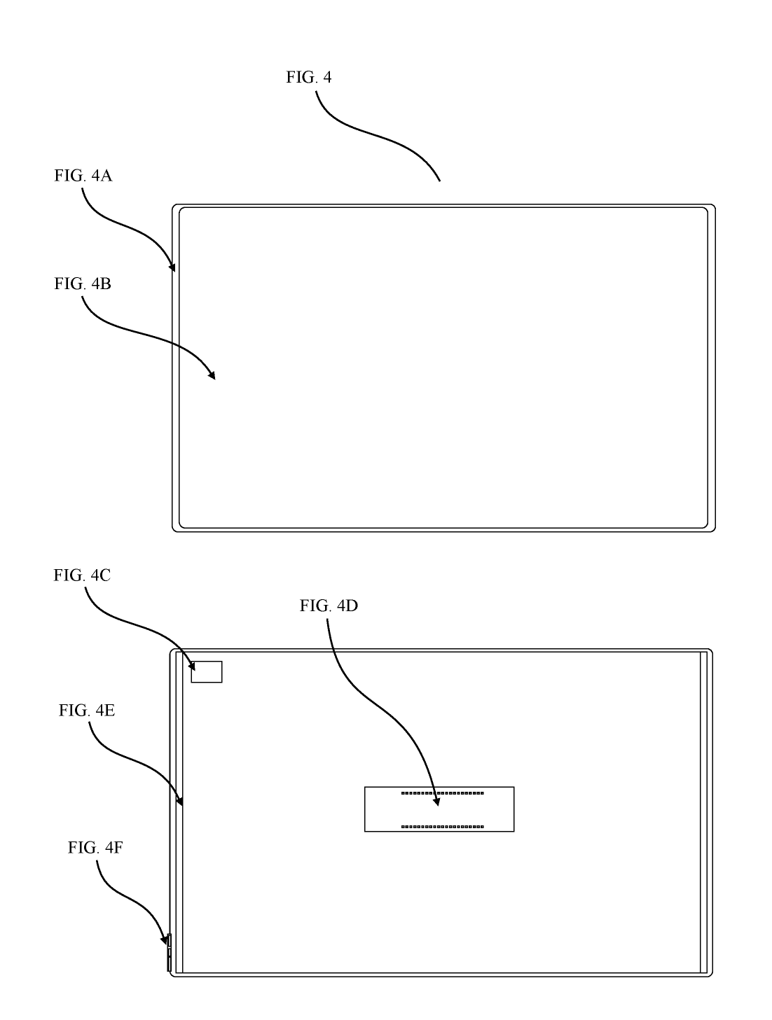

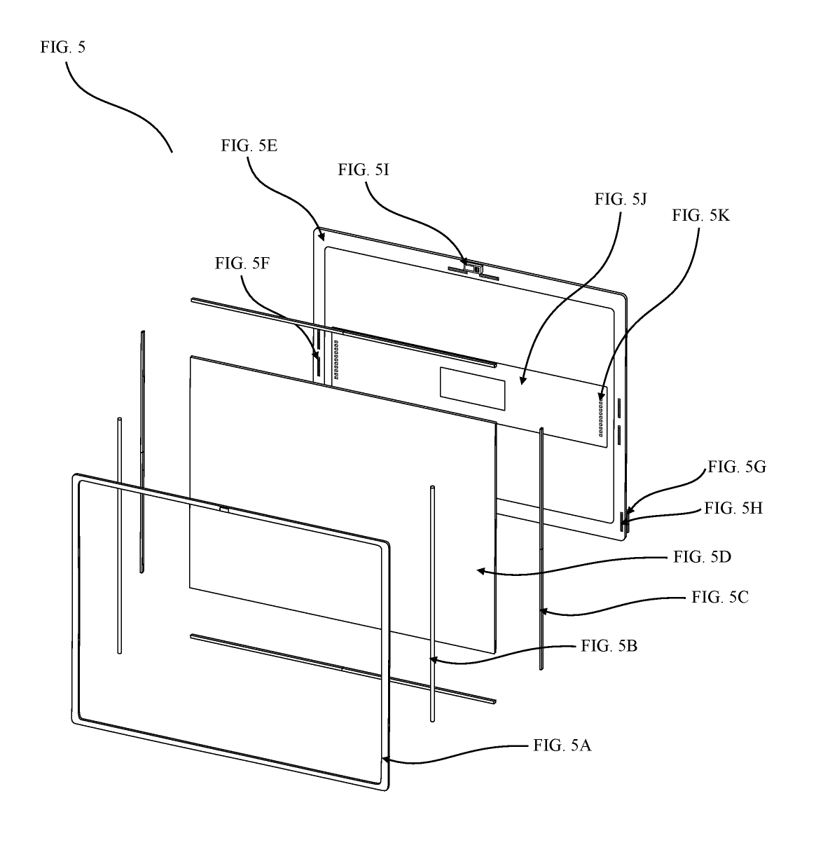

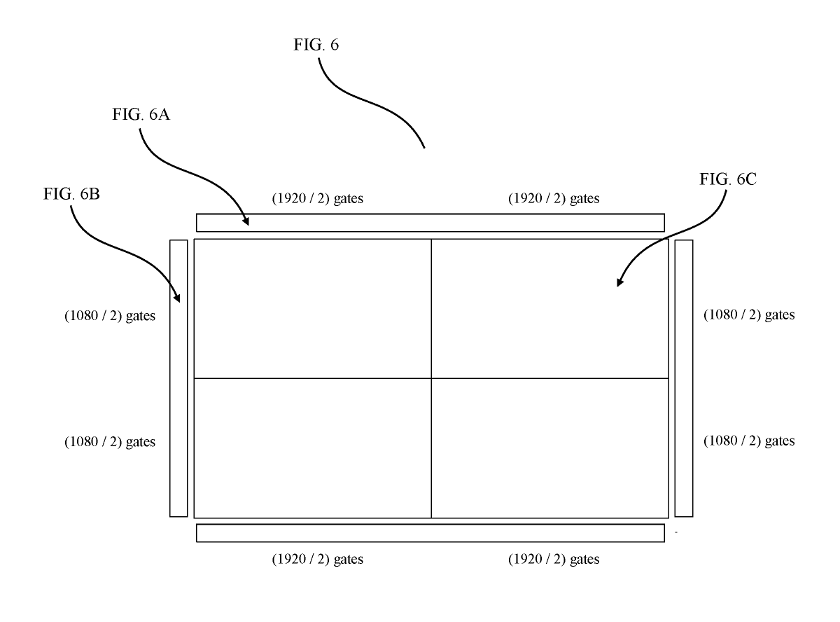

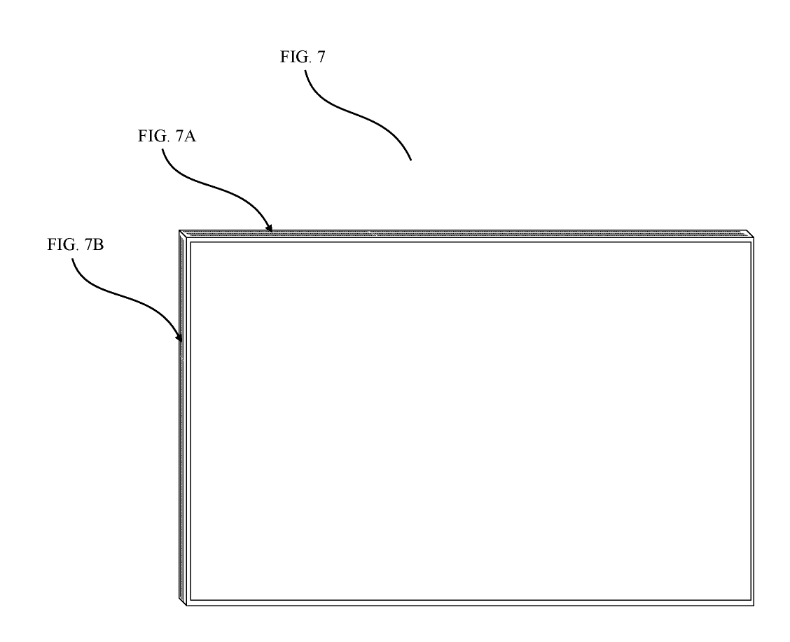

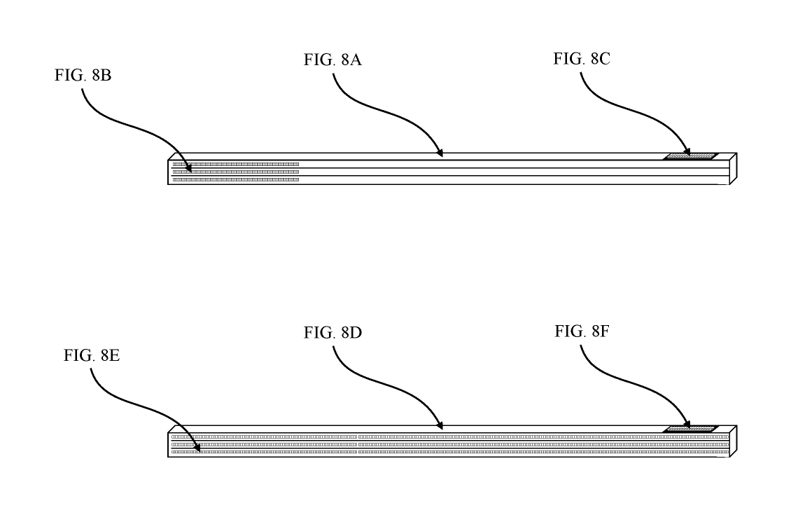

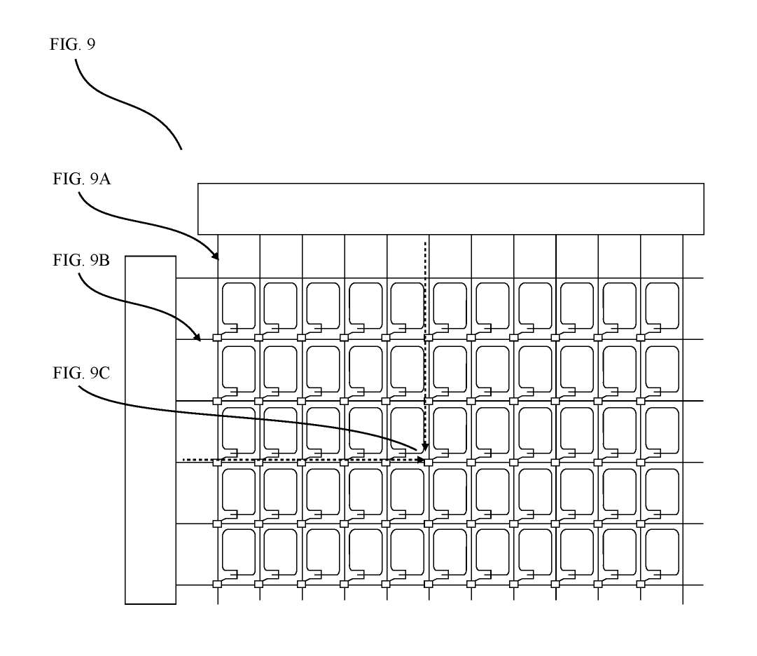

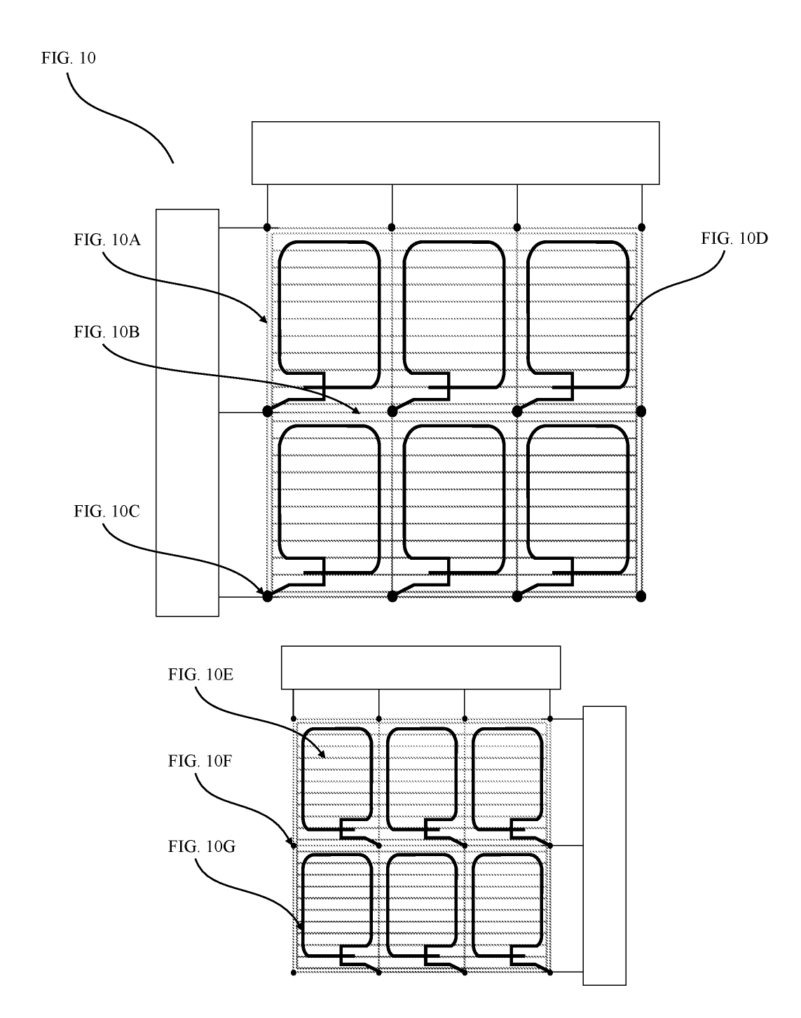

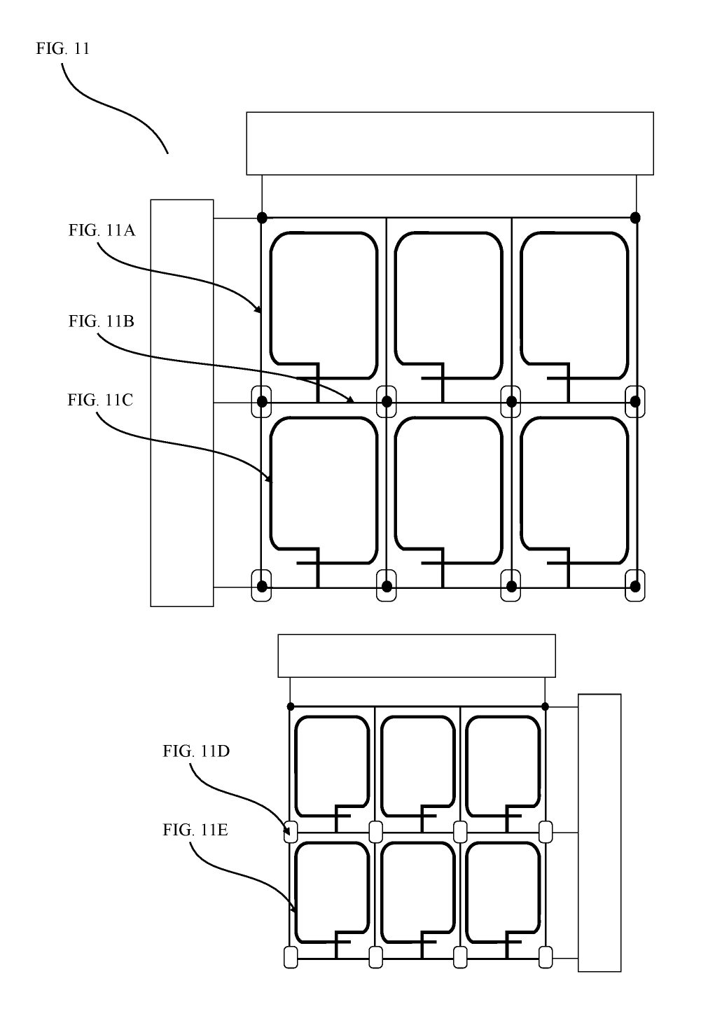

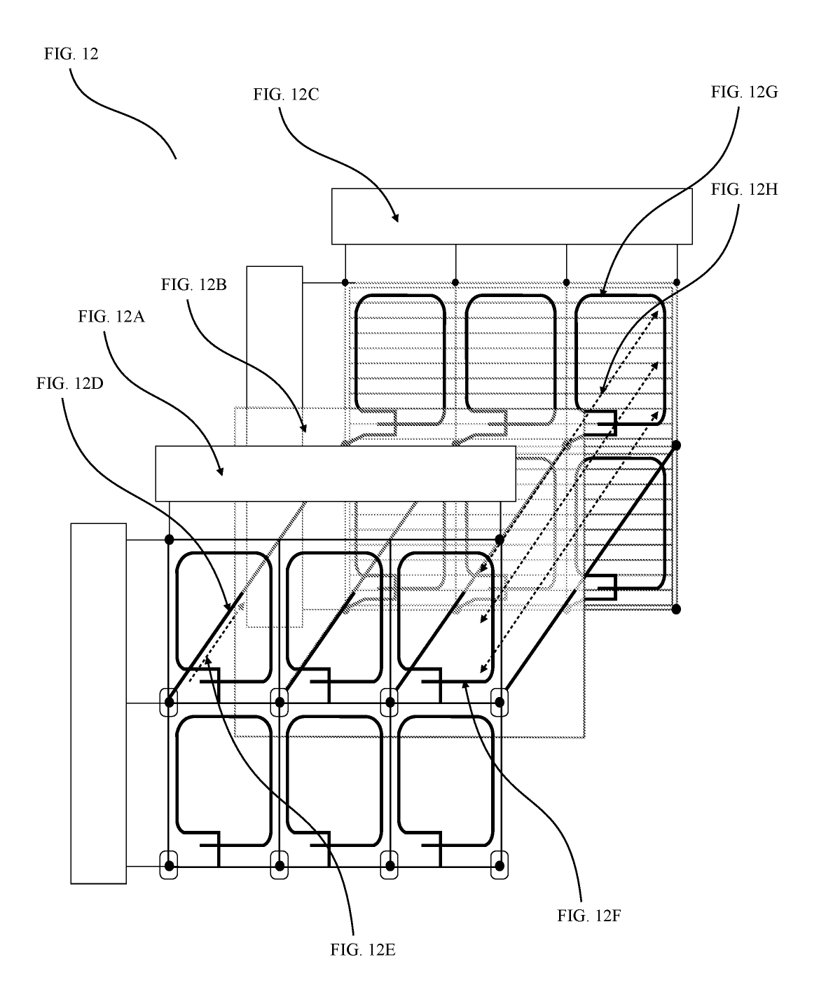

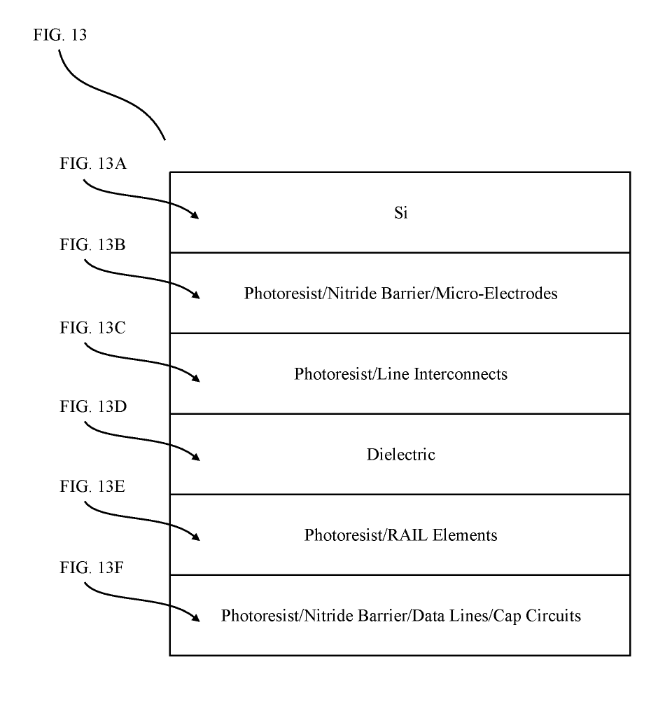

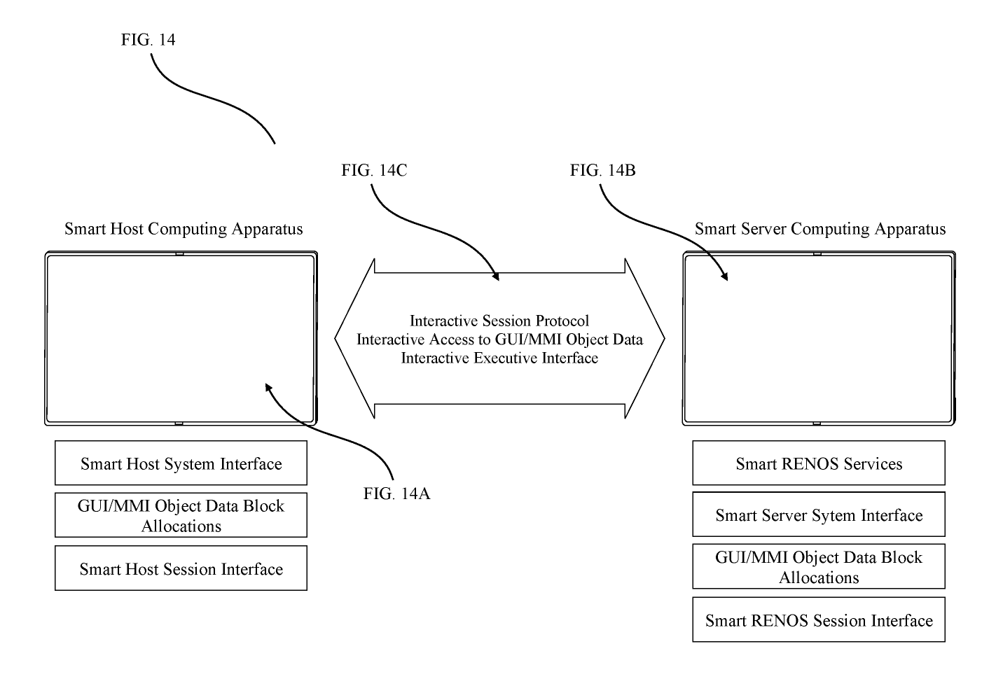

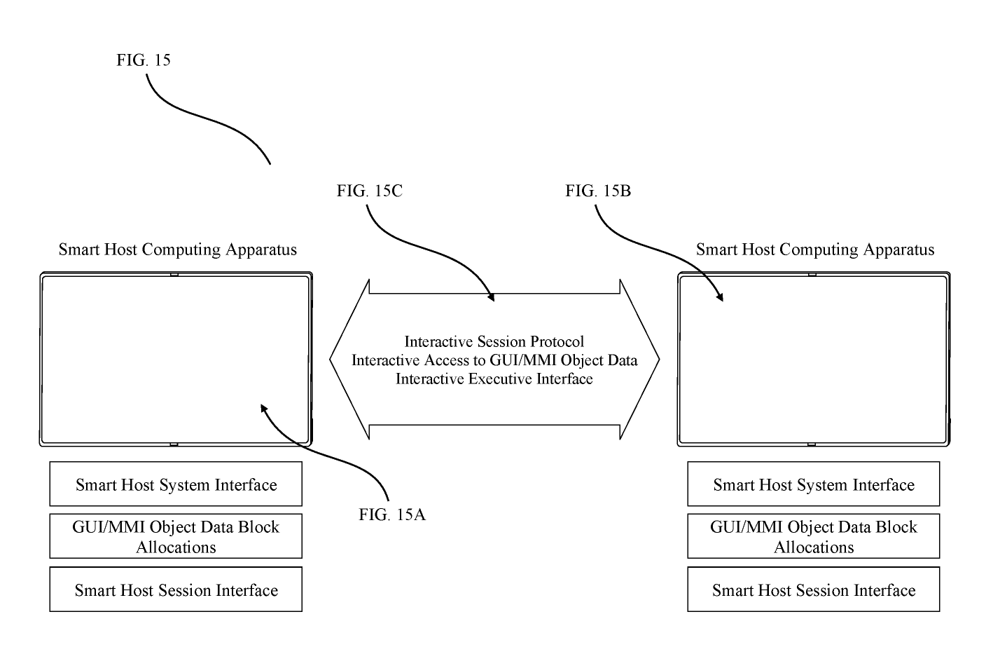

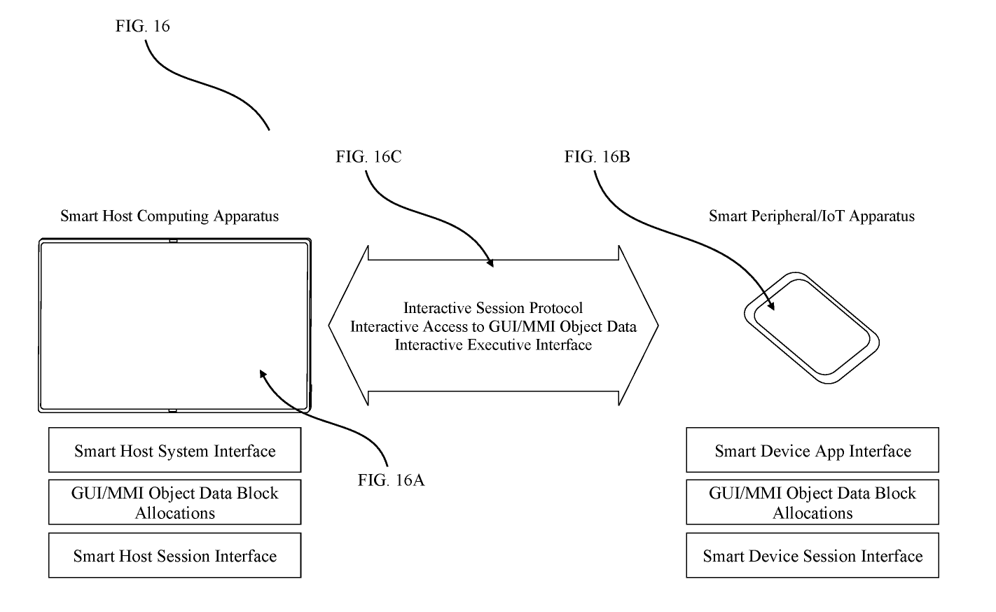

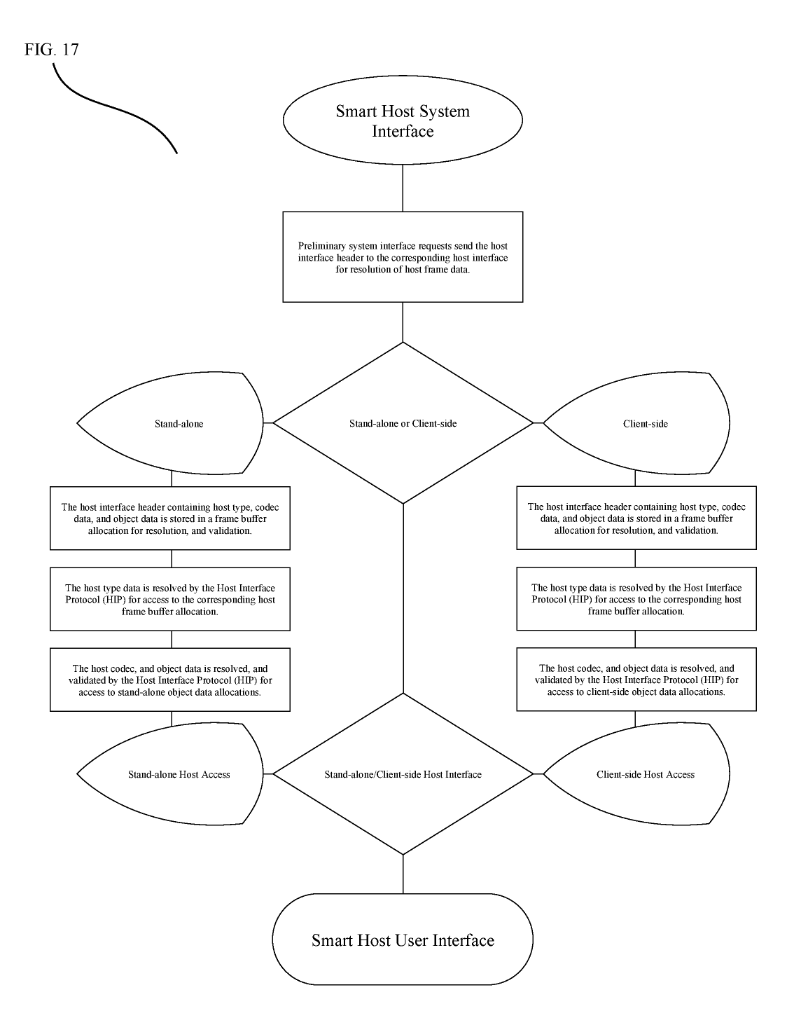

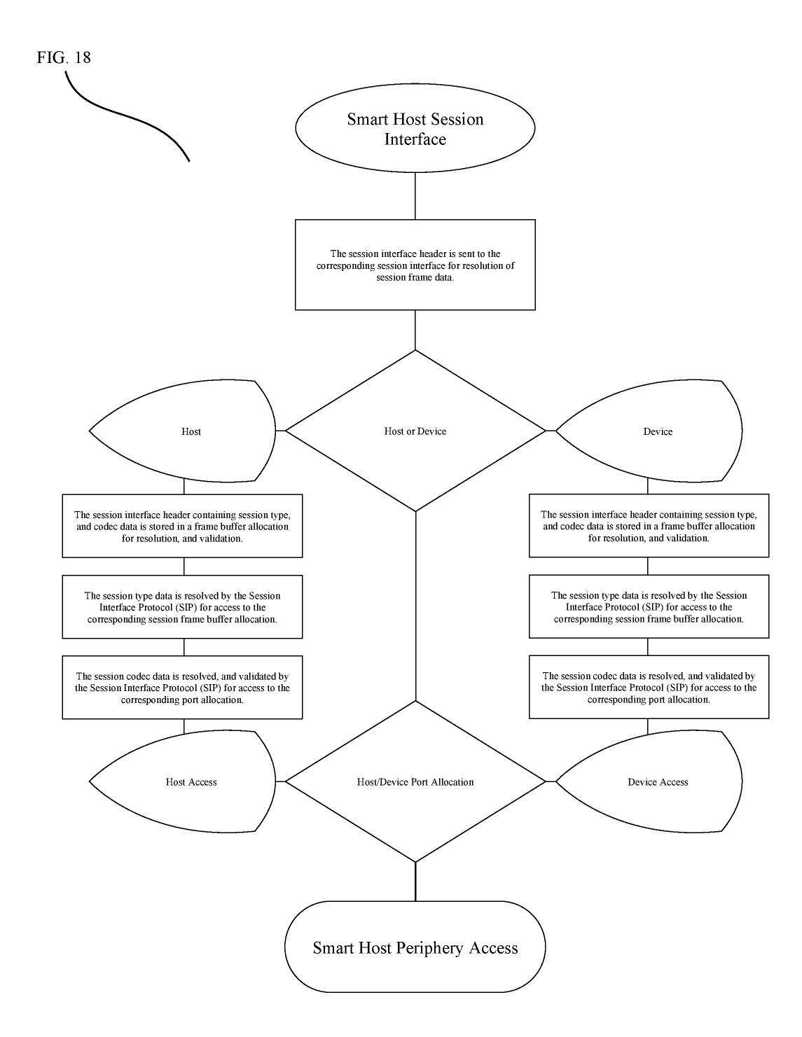

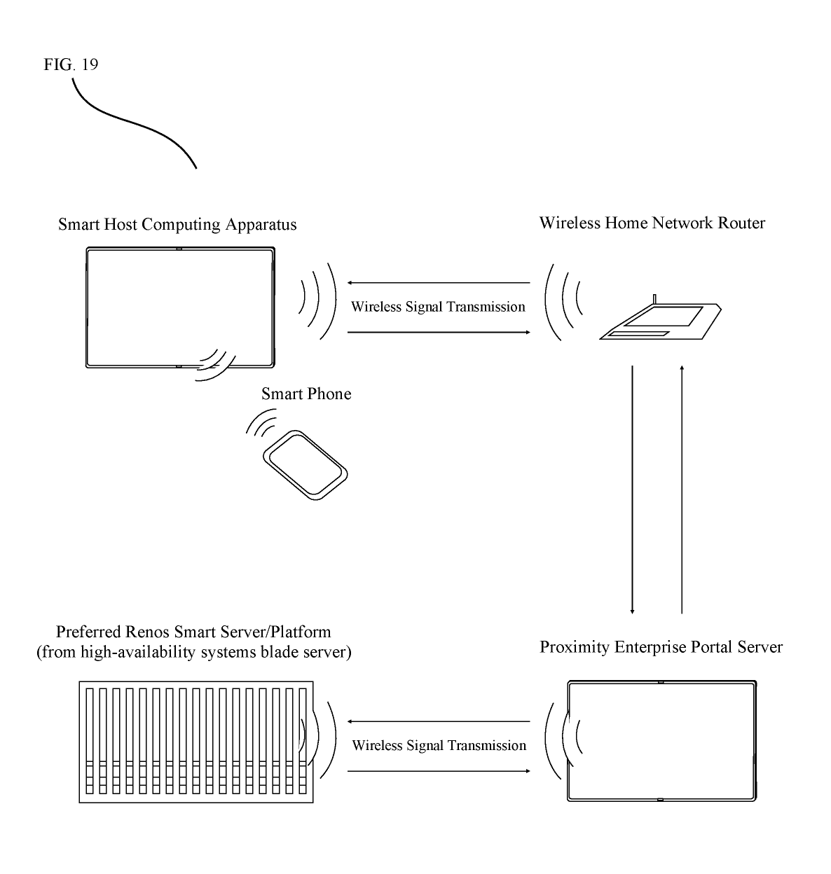

### A DETAILED DESCRIPTION OF THE INVENTION

The present invention embodies a wireless display device composed of a client-side integrated-circuitry infrastructure, and display apparatus. The client-side integrated-circuitry infrastructure consists of multiple integrated-circuitry components, referred to as microchip transistor bit set assemblies, which consist of multiple integrated-circuitry sub-components which serve as a modular integrated framework of memory infrastructure components for system interface operability. The memory infrastructure components serve as the storage components for storage of the object-oriented interface data structure within memory block allocations allocated for the interactive user interface, which consists of graphical user interface object data, multi-media object data, protocol object data, and protocol header data. A display housing assembly serves as the modular architectural framework which encases all of the internal parts of the display apparatus uniformly for electrical connectivity, and integral functionality between all of the internal parts. The display housing assembly encases at least one multi-render interface (MRI) liquid crystal display (LCD) panel assembly, at least one light source, a standard built-in HD web camera interface component, at least one hardware interface component, and at least one power circuitry board component.

The MRI display panel architecture is a thin-film circuit (TFC) display panel architecture which consists of at least two TFC architectural components. At least one MAP component serves as a multi-segmented integrated line-circuitry infrastructure for access to sub-pixel circuits on the display, and at least one MAC component serves as a current source, and drain for the MAP component. Multiple integrated MAP line-circuitry grids can be stacked architecturally to provide a multi-plane interface for access to the primary MAP component, such that the MAP component consists of line interconnects which are integrated at all line intersect coordinates for integrated connectivity with the MAC component, and at least one MAC component consists of line interconnects which are integrated at all line intersect coordinates on the reverse side of the MAC component for integrated connectivity with at least one MAP line-circuitry grid at all line intersect coordinates.

The client-side integrated-circuitry infrastructure is designed for interconnection with the display panel, as an oblong cuboid-shaped microchip consisting of nanoscopic integrated-circuitry transistor bit set assemblies, and an integrated multi-channel short-range wireless signal transceiver. The OLC microchip serves as the microcontroller for the display which drives the sub-pixel signal transmission, stored on a multi-render interface (MRI) memory infrastructure in the form of pixel data, for render on the multi-segmented MAP pixel line-circuitry matrix. The pixel data consists of red, green, and blue signaling data which is stored on multiple integrated-circuitry planes contained in the MRI memory infrastructure, and transmitted to R, G, and B sub-pixel electrodes on the MAP pixel matrix, respectively, for pixel color polarization.

In one embodiment, the integrated line-circuitry on the MAP component consists of sub-pixel micro-electrodes which interconnect with RAIL elements located at every data line intersect coordinate on the MAC component. In this embodiment, the MAC component consists of multiple line-circuitry segments which consist of data lines which extend across two axes, namely, the horizontal axis, and vertical axis. The data lines extending across the vertical axis serve as the electrical line-circuitry media for transmission of sub-pixel load transmission signals across the vertical axis. The data lines extending across the horizontal axis serve as the electrical line-circuitry media for transmission of sub-pixel carrier, and data transmission signals across the horizontal axis.

In one embodiment, the MAC component is partitioned in equal parts into at least four segments, referred to as quadrants; namely, upper right-most, upper left-most, lower right-most, and lower left-most quadrants. MAC component line-circuitry quadrants primarily consists of two sets of lines, namely, carrier lines, and load lines. The carrier lines, and load lines contained in each of the quadrants are actively biased by voltage supplied by a standard current source architecture. The preliminary current supplied to the MAC component provides a preliminary partial reverse-bias for RAIL elements located line intersect coordinates, for decreased load resistance in signal transmission. In this embodiment, the MAC component consists of four line-circuitry quadrants which serve as the line circuitry used for display of graphical user interface object data, and multi-media object data. The MAC component is constructed with the row lines crossing perpendicularly to column lines. The column lines serve as load lines which propagate the load signal transmission across the entire length of the line along the vertical axis. The row lines serve as carrier lines which propagate the data signal transmission across the entire length of the line along the horizontal axis. The data lines on the MAC component interconnect at each line intersection with sub-pixel RAIL elements which are integrated at every line intersection, such that every line intersection consists of one RAIL element which serves as a load resistor for simple resistance between the MAC line circuitry, and the sub-pixel electrodes located on the MAP component, for controlled access to sub-pixel electrodes. The micro-electrodes on the MAC component interconnect with MAC data lines at ever line intersect coordinate, and serve as micro-anodes for sub-pixel circuits located on the MAP component.

The MAC component serves as the independent current source for the MAP component which consists of an integrated line-circuitry infrastructure, which supplies a constant supply current for signal retention for sub-pixel electrodes on the MAP component. Signal retention in sub-pixel electrodes is maintained by positively charged electric current produced by the difference in electric potential between the electrodes located on both display panel architecture components, by means of a high-k dielectric surface substrate located between the two components. The MAC component is designed as an elementary line-circuitry grid which consists of RAIL elements which are integrated at line intersect coordinates to serve as simple resistance diodes for controlled access to MAP electrodes. The MAC component serves as the drain redirect circuitry for redirection of supply current from MAC electrodes to the negative voltage supply on the MAC line-circuitry grid, for sub-pixel reset, and black color polarization on the display. The supply voltage for the MAC component is not limited to direct current; an independent current source, such as an RLC electrical-circuitry infrastructure, can also be employed to provide a constant supply of alternating current for the MAC component.

In one embodiment, the carrier line signal is transmitted to the corresponding row circuit along the horizontal axis, and the load line signal is transmitted to the corresponding column circuit along the vertical axis. The sum of the voltage of the current source, and the carrier signal transmission serve as a differential reverse-bias on the resistance of the RAIL elements for transmission of sub-pixel data to sub-pixel circuits located at line intersect coordinates. The load signal transmission is propagated across the corresponding sub-pixel column to the corresponding carrier line for standard load bias on the corresponding RAIL element interconnect for color polarization at the corresponding sub-pixel line intersect coordinate. The carrier signal is propagated across the corresponding RAIL element for storage on the sub-pixel circuit located on the MAP component. The sub-pixel color polarization signal is maintained by the micro-anode circuit located on the MAC component, directly across the sub-pixel circuit.

The sub-pixel architecture can consist of a variety of elementary architectural standards. In one embodiment a pixel well architecture (such as the one noted in U.S. Pat. No. 8,149,183 B2) consisting of a basin with one or more sidewalls is implemented. In yet another embodiment a sub-pixel micro-electrode line-circuitry architecture is implemented.

The OLC microchip object-oriented integrated circuitry, and data infrastructure acts as a system on a chip (SoC) which provides automated access, and user access to graphical object data stored in object data memory block allocations located within the memory infrastructure built into the microchip. In one embodiment, the OLC microchip also consists of at least one phase-locked loop (PLL) clock, and at least one clock-differential frame buffering integrated-circuitry infrastructure, both of which provide the system interface with multi-clocking, and synchronized frame buffering capabilities. Short-range wireless discovery is accomplished by means of a near field communication (NFC) proximity algorithm which implements a simple data transfer, and timing algorithm for resolution of wireless proximity. All object data consists of header data which is utilized by system protocols for host resolution, session resolution, and data resolution.

Objects are resolved by the system interface, and transmitted to the multi-render interface which consists of a multi-plane integrated-circuitry infrastructure. In one embodiment, the multi-render interface consists of, but is not limited to, five integrated-circuitry planes, namely, the object render interface (ORI) plane, the multi-media interface (MMI) plane, the graphical user interface (GUI) plane, the desktop render interface (DI) plane, and the interactive interface (II) plane. Object render interface object data is stored on the ORI render plane, which is referred to as a desktop pointer block allocation, for independent refresh of user multi-render interface object data on the display. Multi-media interface object data is stored on the MMI render plane, which is referred to as a multi-media pointer block allocation, for independent refresh of multi-media object data on the ORI plane. Graphical user interface object data is stored on the GUI render plane, which is referred to as a GUI pointer block allocation, for independent refresh of graphical object data on the ORI plane. Desktop interface object data is stored on the DI render plane, which is referred to as a desktop pointer block allocation, for independent refresh of desktop object data on the ORI plane. Interactive interface object data is stored on the II render plane, which is referred to as an interactive pointer block allocation, for independent refresh of interactive object data on the ORI plane. The ORI render plane is utilized by the MMI, GUI, DI, and II render planes for autonomous object-oriented interactive capabilities for graphical user interface, and multi-media objects. The II interface plane consists of the integrated-circuitry infrastructure which serves as a frame buffer for pixel data frames for resolution of block address data contained therein, for interactive access to graphical object data, and instruction set data stored within corresponding subcomponent pointer block allocations.

The MRI display panel architecture provides the smart host system interface with electrical access to multiple quadrants on the display, on multiple planes, allowing it to render multiple graphical blocks of pixel data simultaneously, as emulated access to a squared matrix of pixels. The display assembly design infrastructure is not limited for use as a standard LCD display interface. A touch-sensitive screen interface component fabricated with any one of a variety of polymer materials, such as glass, or plastic, can also be employed as a built-in display input component by means of a touch-screen component interconnect port which is built into the power circuitry board.

At least one integrated multi-channel short-range wireless signal transceiver provides wireless network connectivity with compatible wireless devices, and remote hosts.

A built-in HD web camera interface component infrastructure provides video rendering capabilities for localized video capture, and video transmission to remote hosts. In one embodiment, the HD web camera consists of a microphone which serves as the microphone interface for the smart host computing apparatus, and a web camera interconnect port component which interconnects with the power circuitry board, and the OLC infrastructure for integrated functionality with the smart host computing apparatus.

A hardware interface component infrastructure provides the smart host apparatus with audio interface capabilities for wired audio signal transmission, and wired serial bus connectivity for micro-B USB compatible devices. In one embodiment, the hardware interface component infrastructure consists of an invariably constituent variation of an interconnect port for electrical connectivity with the power circuitry board, a microphone jack, a headphone/speaker jack, a micro-B USB port, and a power control button.

All of the afore-mentioned components function integrally as a system to provide the smart host computing apparatus with a rich enterprise service-oriented computing infrastructure which consists of multi-rendering capabilities, a rich enterprise interactive user interface, and universal cross-platform portability for interconnectivity with compatible wireless peripheral devices, and remote hosts.

What is claimed is:

1. A rich enterprise service-oriented client-side integrated-circuitry infrastructure, and display apparatus, which consists of a display housing assembly, a multi-render interface (MRI) liquid crystal display (LCD) panel assembly, at least one light source component, a standard built-in HD web camera interface component, at least one hardware interface component, and at least one power circuitry board component.

2. A sub-component of the apparatus mentioned in claim 1, referred to as the display housing assembly, wherein a display housing assembly which is coupled, by means of a snap-on, or bolt-on design infrastructure, over the entire internal assembly of parts to serves as a solidified encasement for the MRI LCD display panel assembly mentioned in claim 1, with an internal design infrastructure which houses a standard built-in HD web camera interface component, at least one hardware interface component, a power circuitry board component, and an invariably constituent design infrastructure consisting of, but not limited to, a battery compartment cover, and a display stand, all of which are encased in their specified positions, interconnected according to the parts interconnect design infrastructure specification for the apparatus.

3. A sub-component of the MRI LCD display panel assembly mentioned in claim 2, referred to as the MRI LCD display panel architecture, wherein a MRI LCD display panel architecture consists of multiple thin-film circuit (TFC) display panel architecture components, referred to as MRI components, and an integrated-circuitry design infrastructure consisting of at least one oblong line-circuitry (OLC) silicon microchip, wherein multiple MRI components serve as a singular integral display panel line-circuitry infrastructure with an array of data lines extending to at least one side of the display panel for interconnection with at least one OLC microchip, and at least one OLC microchip interconnects with the display panel by means of a built-in OLC interconnect port on at least one side of the display panel consisting of at least one MRI component interconnect port electrically coupled to at least one built-in MRI component.

4. A sub-component of the MRI LCD display panel assembly mentioned in claim 3, referred to as the MRI display panel architecture, wherein at least one MAP component consists of a sub-pixel micro-electrode architecture, and at least one MAC component consists of a capacitance micro-electrode line-circuitry architecture, wherein a MAP component serves as the line circuitry which consists of sub-pixel micro-electrode circuits consisting of line interconnects which interconnect with RAIL elements located on the MAC component, and a MAC component serves as the line-circuitry architecture which provides access to at least one MAP line-circuitry matrix, and constant supply current for sub-pixel circuits located on the MAP component.

5. A sub-component of the MRI LCD display panel assembly mentioned in claim 3, referred to as the OLC silicon microchip, wherein an integrated-circuitry design infrastructure consisting of at least one OLC silicon microchip is modularly interconnected with the display panel on at least one side of the panel by means of an interconnect port, and the OLC microchip consists of a modular integrated framework of transistor bit set assemblies which serve as modular integrated circuitry infrastructure components, wherein at least one serves as system interface component for interactive user interface with the smart host computing apparatus, at least one other serves as a session interface component for interactive user interface with the smart host computing apparatus, at least one other serves as a multi-render interface component for multi-plane rendering capabilities, at least one other serves as a wireless communication interface component which acts as a multi-channel short-range wireless transceiver for the apparatus, and at least one other serves as a gate logic array for resolution of line interconnect coordinates located on the MAC component.

6. A component of the OLC microchip mentioned in claim 5, referred to as the smart host system interface component, wherein at least one built-in modular integrated-circuitry infrastructure serves as a modular system line-circuitry interface which provides the smart host computing apparatus with host resolution capabilities, wherein at least one host interface protocol is implemented for resolution of encoded host data frames for validation, and access to corresponding host memory block allocations which contain protocol object data, graphical object data, and multi-media object data.

7. A sub-component of the smart host system interface component mentioned in claim 6, referred to as the stand-alone host interface module, wherein at least one built-in modular integrated-circuitry infrastructure is integrated as a sub-component of the smart host system interface component, and provides the smart host computing apparatus with stand-alone user interface capabilities by means of at least one stand-alone interface protocol for interactive executive access to corresponding stand-alone memory block allocations.

8. A sub-component of the smart host system interface component mentioned in claim 6, referred to as the client-side host interface module, wherein at least one built-in modular integrated-circuitry infrastructure is integrated as a sub-component of the smart host system interface component, and provides the smart host computing apparatus with client-side user interface capabilities by means of at least one client-side interface protocol for interactive executive access to corresponding client-side memory block allocations.

9. A component of the OLC microchip mentioned in claim 5, referred to as the smart host session interface component, wherein at least one built-in modular integrated-circuitry infrastructure serves as a modular system line-circuitry interface which provides the smart host computing apparatus with session resolution capabilities, wherein at least one session interface protocol is implemented for resolution of encoded session data frames for validation, and port assignment, for access to the interactive executive interface for interactive connectivity between the smart host computing apparatus, and other smart apparatuses.

10. A sub-component of the smart host session interface component mentioned in claim 9, referred to as the host session interface module, wherein at least one built-in modular integrated-circuitry infrastructure is integrated as a sub-component of the smart host session interface component, and provides the smart host computing apparatus with interactive connectivity with remote host apparatuses by means of at least one session interface protocol for interactive executive access between smart hosts.

11. A sub-component of the smart host session interface component mentioned in claim 9, referred to as the device session interface module, wherein at least one built-in modular integrated-circuitry infrastructure is integrated as a sub-component of the smart host session interface component, and provides the smart host computing apparatus with interactive connectivity with peripheral devices by means of at least one session interface protocol for interactive executive access between the smart host computing apparatus, and peripheral devices.

12. A component of the OLC microchip mentioned in claim 5, referred to as the smart host multi-render interface component, wherein at least one built-in modular integrated-circuitry infrastructure serves as a modular system line-circuitry interface which provides the smart host computing apparatus with multi-plane rendering capabilities, wherein a modular framework of multiple integrated-circuitry planes serve as a singular multi-plane integrated-circuitry infrastructure consisting of the drive electronics used for storage, interface, and transmission of pixel data to multiple MAP components at differentially clocked refresh rates.

13. A component of the rich enterprise service-oriented client-side integrated-circuitry infrastructure, and display apparatus mentioned in claim 1, referred to as the light source component, wherein at least one light source component consisting of, but not limited to, either a CCFL lamp, or LED light strip, serves as the light source for the display panel.

14. A component of the rich enterprise service-oriented client-side integrated-circuitry infrastructure, and display apparatus mentioned in claim 1, referred to as the HD web camera interface component, wherein the display apparatus consists of a standard built-in HD web camera interface component, at least one microphone interface component, and at least one web camera interface component interconnect port, wherein the HD web camera interface component provides the apparatus with a standard progressive scan capability with 720p-1080p resolution, and at least one web camera interface component interconnect port extends across the depth of the OLC silicon microchip for interconnection with the power circuitry board for electrical connectivity with the voltage source, and video transmission line-circuitry infrastructure built into the power circuitry board.

15. A component of the rich enterprise service-oriented client-side integrated-circuitry infrastructure, and display apparatus mentioned in claim 1, referred to as the hardware interface component, wherein the display apparatus consists of a hardware interface component consisting of at least one audio interface jack, one micro-B USB interface connector port, and one power control button, wherein the hardware interface component consists of multiple built-in interface components, and at least one power circuitry board female-pin interconnect port.

16. A component of the rich enterprise service-oriented client-side integrated-circuitry infrastructure, and display apparatus mentioned in claim 1, referred to as the power circuitry board component, wherein the display apparatus consists of a power circuitry board component consisting of a built-in power adapter connector port component, at least one male-pin OLC microchip interconnect port, one male-pin web camera interface component interconnect port, one male-pin hardware interface component interconnect port, and one male-pin LCD lamp component interconnect port, wherein a power supply component is built into the power circuitry board for electrical connectivity with an external power adapter, at least one port is provided for interconnection with at least one OLC microchip mentioned in claim 5, at least one port is provided for interconnection with at least one HD web camera interface component mentioned in claim 14, at least one port is provided for interconnection with at least one hardware interface component mentioned in claim 15, and the power circuitry board component consists of at least one multi-channel integrated-circuitry infrastructure which serves as the electrical circuitry interface which provides multi-channel switching capabilities between the voltage source and the system architectural components for regulation, and conversion of electrical current by means of at least one built-in electrical power transformer.

17. A specific method of use of claim 1, wherein a smart host computing apparatus mentioned in claim 1 is implemented in a business computing environment as a stand-alone multi-media publishing business computing apparatus which acts as a multi-media web client with internet browsing, multi-media publishing, and video messaging capabilities, and is connected to a local rich enterprise network operating systems server, by means of a wireless access point, and a wireless enterprise session protocol which is implemented by the smart host system interface for interconnectivity with preferred enterprise servers, and for the smart host's internet browsing capabilities.

18. A specific method of use of claim 1, wherein a smart host computing apparatus mentioned in claim 1 is implemented in a business computing environment as a client-side rich enterprise business computing apparatus which acts as a rich client consisting of a remote service-oriented software applications infrastructure for access to rich enterprise network operating systems business software applications, and network resources such as databases, business machines, and cloud infrastructures, wherein the smart host computing apparatus consists of a rich multi-media interface, internet browsing capabilities, multi-media publishing capabilities, video conferencing capabilities, and a rich enterprise open-cloud browsing user interface infrastructure.

19. A specific method of use of claim 1, wherein a smart host computing apparatus mentioned in claim 1 is implemented in a home computing environment as a stand-alone multi-media home computing apparatus with similar capabilities as those mentioned in claim 18 which consists of a rich enterprise user interface which provides the home user with portable access to compatible wireless peripheral devices and compatible IoT devices, internet browsing capabilities, multiple multi-media interactive interfacing capabilities, multi-media publishing capabilities, and video messaging capabilities by means of its rich cross-platform portability.

20. A specific method of use of claim 1, wherein a smart host computing apparatus mentioned in claim 1 is implemented in a home computing environment as a client-side multi-media home computing apparatus with similar capabilities as those mentioned in claim 19 which consists of a rich enterprise user interface which provides the home user with portable access to compatible wireless peripheral devices and compatible IoT devices, internet browsing capabilities, multiple multi-media interactive interfacing capabilities, multi-media publishing capabilities, video messaging capabilities, and access to a licensed operating systems allocation which provides service-oriented operating systems resources, such as access to enterprise operating system platforms for desktop operability, enterprise printing capabilities, smart backup services, smart disaster recovery services, and smart consumer maintenance services by a preferred enterprise portal service provider.

21. A specific method of use of claim 5, wherein a modular integrated-circuitry infrastructure which serves as the system line-circuitry interface is utilized by at least one input device for interactive electronic interface with the apparatus, wherein the input device transmits session control commands, and interactive graphical user interface control commands via a wired, or wireless transport mechanism, and the control commands are resolved for validation for access to interactive system resources.

22. A specific method of use of claim 5, wherein a modular integrated-circuitry framework which serves as the system line-circuitry interface is utilized by multiple data transmission protocol standards for access to system resources, and resolution of multiple types of packetized data, wherein at least one type of data is transmitted via a wireless transport mechanism between a smart host computing apparatus, and a remote host device, and the data contains type, codec, and object header frame data which is stored in at least one protocol frame buffer memory allocation for resolution, and validation thereof.
